(19) United States
(12) Patent Application Publication
(10) Pub. No.: US 2021/0400888 A1
(43) Pub. Date: Dec. 30, 2021

(54) Tree Felling Head Control System and Method

(71) Applicant: Deere & Company, Moline, IL (US)

(72) Inventors: Bryon P. Neumann, Branford (CA); Richard J. Lawler, Dubuque, IA (US)

(21) Appl. No.: 16/946,621

(22) Filed: Jun. 30, 2020

(51) Int. Cl. A01G 23/091; B25J 15/00; A01G 23/00; B25J 9/16

(52) U.S. Cl. CPC A01G 23/091; B25J 15/0023; A01G 3/086; B25J 9/1694; A01G 23/003

(57) ABSTRACT

A tree felling head comprising a frame is coupled to a boom assembly of a harvester. A saw is coupled to the frame and is configured to cut a tree. A sensor that senses cutting of the tree by the saw and outputs a first signal when the tree is cut by the saw. A grapple arm is coupled to the frame. At least one grapple arm actuator is coupled between the frame and the grapple arm. The grapple arm actuator is configured to move the grapple arm between a closed position, a gliding position, and an open position. A control system is in communication with the grapple arm actuator and the sensor. The control system receives the first signal output by the sensor and outputs a second signal to cause the grapple arm actuator to move the grapple arm to the gliding position.

### FIELD OF THE DISCLOSURE

The present disclosure generally relates to tree felling heads, and more particularly to a control system and method for controlling the tree felling head coupled to a harvester.

### BACKGROUND OF THE DISCLOSURE

Tree felling heads typically dangle on the end of the stick boom of a forestry machine. After the felling head has cut a tree, an operator has only limited ability to control the felling head in order to influence the direction or force with which the tree falls to the ground.

### SUMMARY OF THE DISCLOSURE

In one embodiment, a tree felling head is disclosed. The tree felling head is coupled to a boom assembly of a harvester. The tree felling head comprises a frame. A saw is coupled to the frame and is configured to cut a tree. A sensor is provided that senses cutting of the tree by the saw. The sensor outputs a first signal when the tree is cut by the saw. A grapple arm is coupled to the frame. At least one grapple arm actuator is coupled to the frame and the grapple arm. The grapple arm actuator is configured to move the grapple arm between a closed position in which the tree is held by the tree felling head, a gliding position in which the tree is allowed to slide relative to the tree felling head, and an open position in which the tree is released from the tree felling head. A control system is in communication with the grapple arm actuator and the sensor. The control system receives the first signal output by the sensor and outputs a second signal to cause the grapple arm actuator to move the grapple arm to the gliding position when the first signal output by the sensor is received.

In another embodiment, a harvester is disclosed. The harvester comprises an upper frame assembly. A boom assembly is coupled to the upper frame assembly. A tree felling head is coupled to the boom assembly. The tree felling head comprises a frame. A saw is coupled to the frame and is configured to cut a tree. A sensor is provided that senses cutting of the tree by the saw. The sensor outputs a first signal when the tree is cut by the saw. A grapple arm is coupled to the frame. At least one grapple arm actuator is coupled to the frame and the grapple arm. The grapple arm actuator is configured to move the grapple arm between a closed position in which the tree is held by the tree felling head, a gliding position in which the tree is allowed to slide relative to the tree felling head, and an open position in which the tree is released from the tree felling head. A control system is in communication with the grapple arm actuator and the sensor. The control system receives the first signal output by the sensor and outputs a second signal to cause the grapple arm actuator to move the grapple arm to the gliding position when the first signal output by the sensor is received.

In yet another embodiment, a method for cutting a tree with a harvester is disclosed. The harvester is provided with a boom assembly and a tree felling head. The method comprises providing a sensor for sensing when the tree is cut by a saw of the tree felling head. The method further comprises moving a grapple arm of the tree felling head to a gliding position.

Other features and aspects will become apparent by consideration of the detailed description and accompanying drawings.

### BRIEF DESCRIPTION OF THE DRAWINGS

FIG. 1 is a perspective view of a work vehicle according to one embodiment with a felling head.

FIG. 2A is a perspective view of the felling head showing a cutting saw in a cutting position.

FIG. 2B is a perspective view of the felling head showing a cutting saw in a stored position

FIG. 3A is a top view illustrating grapple arms of the felling head in a closed position.

FIG. 3B is a top view illustrating grapple arms of the felling head in a gliding position.

FIG. 3C is a top view illustrating grapple arms of the felling head in an open position.

FIG. 4 is a schematic of a control system for the felling head.

FIG. 5 is a flow diagram of a method for cutting a tree with a harvester.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the invention may include any combination of features from one or more dependent claims, and such features may be incorporated, collectively or separately, into any independent claim.

As used herein, unless otherwise limited or modified, lists with elements that are separated by conjunctive terms (e.g., “and”) and that are also preceded by the phrase “at least one of” or “one or more of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

### DETAILED DESCRIPTION

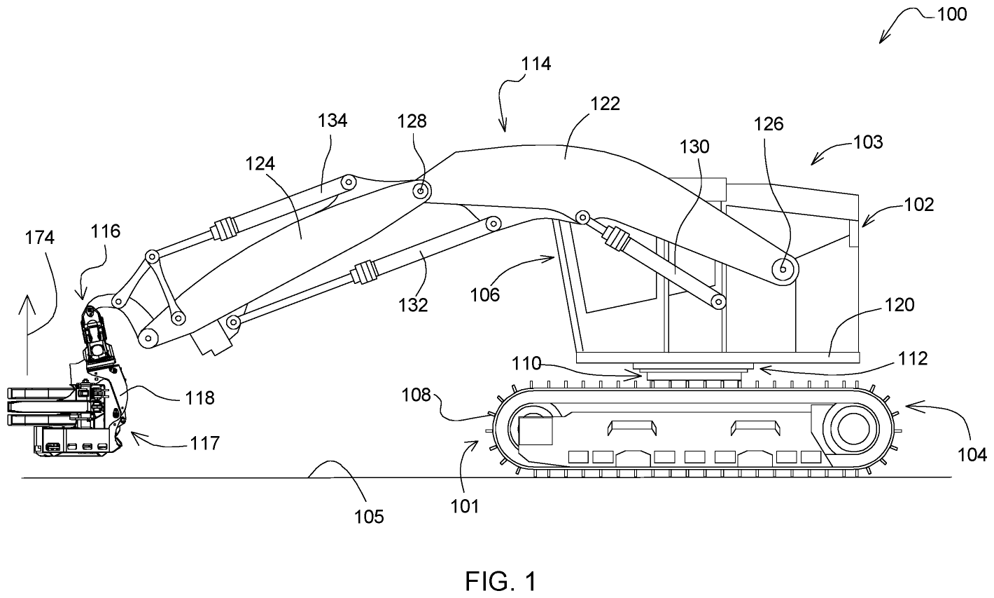

FIG. 1 illustrates a work vehicle 100 supported by an undercarriage assembly 104 having a plurality of ground-engaging devices 101. The ground-engaging devices 101 are configured to support the work vehicle 100 on a surface 105. The illustrated ground-engaging devices 101 are tracks 108. Alternatively, the ground-engaging devices 101 may be a set of front wheels and a set of rear wheels (not shown).

The illustrated work vehicle 100 is a harvester 103. The harvester 103 includes an upper frame assembly 102 which is supported by the tracks 108. The upper frame assembly 102 may include an operator's station 106. Alternatively, the operator may operate the harvester 103 remotely. A plurality of operator inputs (e.g., joysticks, pedals, buttons, screens) for controlling the harvester 103 may be provided in the operator's station 106. The upper frame assembly 102 may also include an engine compartment that houses a prime mover (not shown). The prime mover may be a diesel engine, which provides power for operating the harvester 103.

The upper frame assembly 102 may be mechanically coupled to the undercarriage assembly 104 by a tilt mechanism and turntable assembly 110. The tilt mechanism and turntable assembly 110 operably controls the work vehicle 100 to be rotated and tilted about one or more axes. A swing assembly 112, for example, includes one or more swing motors (not shown) for driving rotation of the upper frame assembly 102 relative to the undercarriage assembly 104. Operation of the swing assembly 112 rotates a platform 120 of the upper frame assembly 102 relative to the undercarriage assembly 104.

With continued reference to FIG. 1, the harvester 103 includes a boom assembly 114 that is coupled to the upper frame assembly 102. The boom assembly 114 may include a first boom section 122 and a second boom section 124. The first boom section 122 may be coupled to the upper frame assembly 102 via a first pivot joint 126. The first boom section 122 may be coupled to the second boom section 124 via a second pivot joint 128. The second boom section 124 may also be coupled to a wrist assembly 116.

To manipulate the position of the boom assembly 114 with respect to the upper frame assembly 102 the harvester 103 includes a boom actuator 130. One portion of the boom actuator 130 is coupled to the upper frame assembly 102 and another portion is connected to the first boom section 122. A second boom actuator 132 may be coupled to the first boom section 122 and the second boom section 124 to pivot the second boom section 124 with respect to the first boom section 122. A third boom actuator 134 is coupled between the second boom section 124 and the wrist assembly 116. The position of the wrist assembly 116 is controlled by extending or retracting the boom actuator 130, the second boom actuator 132 and the third boom actuator 134. In an exemplary scenario, to raise the wrist assembly 116 the boom actuator 130 is extended which further pivots the boom assembly 114 about the first pivot joint 126.

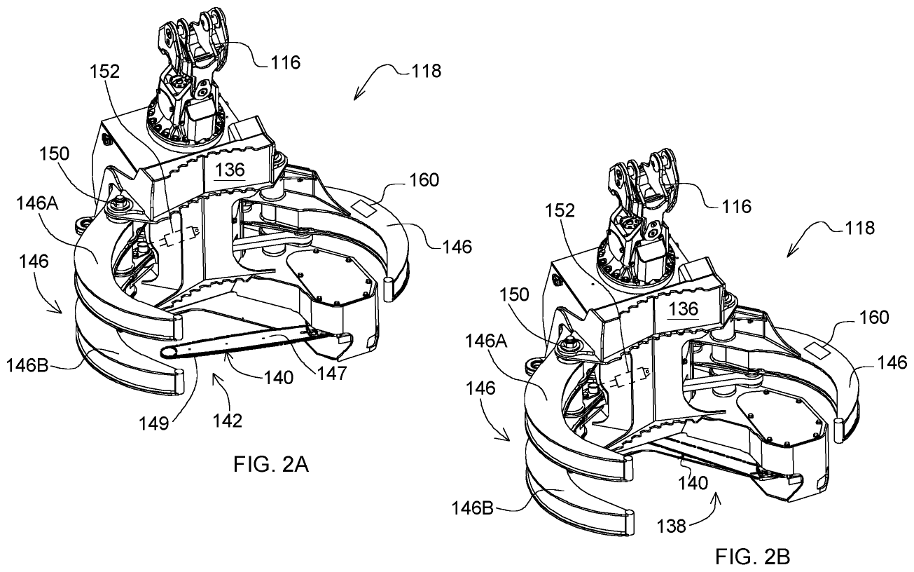

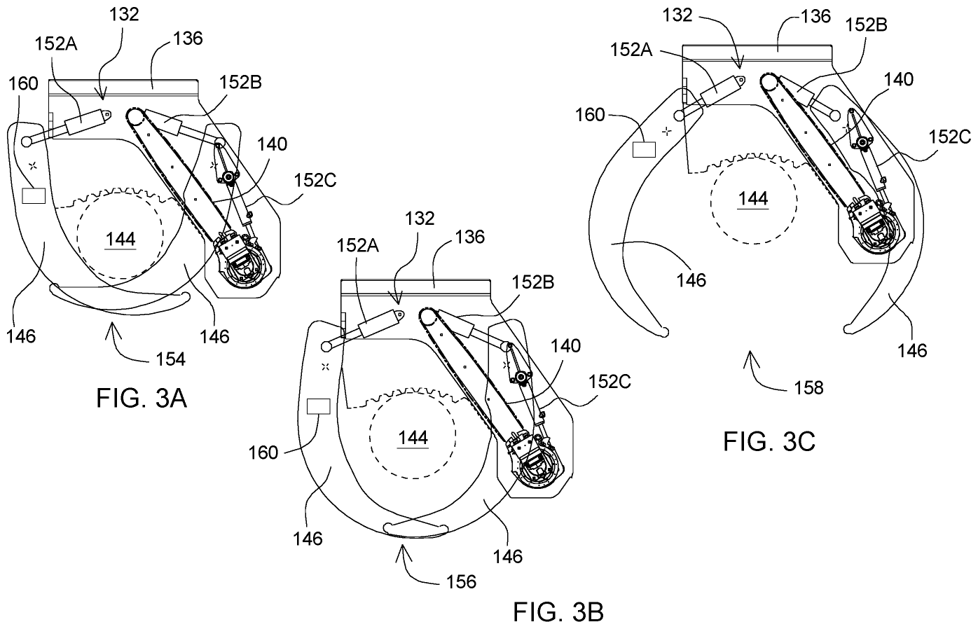

Referring to FIGS. 1, 2A, and 2B, a work implement 117 is coupled to the wrist assembly 116 of the boom assembly 114. The illustrated work implement 117 is a tree felling head 118 for harvesting a tree 144 (FIGS. 3A-3C). The tree felling head 118 comprises a frame 136 to support various components of the tree felling head 118. In the embodiment shown in FIGS. 2A-2B the frame 136 of the tree felling head 118 supports a saw 140 and a grapple arm 146. The frame 136 also supports a plurality of actuators 152A, 152B, 152C (FIGS. 3A-3C) to control the positions of the saw 140 and the grapple arm 146.

With continued reference to FIGS. 2A-2B, in one embodiment the saw 140 is coupled to the frame 136 and is configured to move from a stored position 138 (as shown in FIG. 2B) to a cutting position 142 (as shown in FIG. 2A) to cut the tree 144 (FIGS. 3A-3C). The saw 140 may be moved by a saw actuator 152C (FIGS. 3A-3C). The saw 140 may comprise a bar 147 and chain 149. The saw actuator 152C may be an electronic actuator, a hydraulic actuator, a hydraulic motor or an electric motor.

FIG. 2A illustrates the tree felling head 118 with the grapple arm 146. The grapple arm 146 is coupled to the frame 136 at an arm pivot joint 150. At least one grapple arm actuator 152 is coupled to the frame 136 and the grapple arm 146. The grapple arm actuator 152 may be an electric actuator or a hydraulic actuator. The grapple arm actuator 152 is configured to move the grapple arm 146 between a closed position 154 in which the tree 144 is held by the tree felling head 118 (FIG. 3A), a gliding position 156 in which the tree 144 is allowed to slide relative to the tree felling head 118 (FIG. 3B), and an open position 158 in which the tree 144 is released from the tree felling head 118 (FIG. 3C).

FIGS. 3A-3C illustrate three exemplary positions of the grapple arm 146. In the closed position 154 of the grapple arm 146 as shown in FIG. 3A, the grapple arm actuator 152 may be extended to a maximum limit such that the grapple arm 146 holds the tree 144 tightly to avoid any slip between the tree 144 and the grapple arm 146. In the gliding position 156 as shown in FIG. 3B, the grapple arm 146 is retracted some such that the grapple arm 146 may make a narrow gap between the grapple arm 146 and the tree 144. In this position, the tree 144 can slide with respect to the grapple arm 146. In the open position 158 as shown in FIG. 3C, the grapple arm actuator 152 is retracted such that the tree 144 falls from the tree felling head 118.

As illustrated in FIGS. 2A-3C, the grapple arm 146 may comprise a pair of grapple arms 146A, 146B. and the grapple arm actuator 152 may comprise a pair of grapple arm actuators 152A, 152B. The pair of grapple arms 146A, 146B and the pair of grapple arm actuators 152A, 152B are connected to either side of the frame 136 such that the pair of grapple arms 146A, 146B are controlled by the respective grapple arm actuator 152A, 152B connected between the grapple arm 146 and the frame 136.

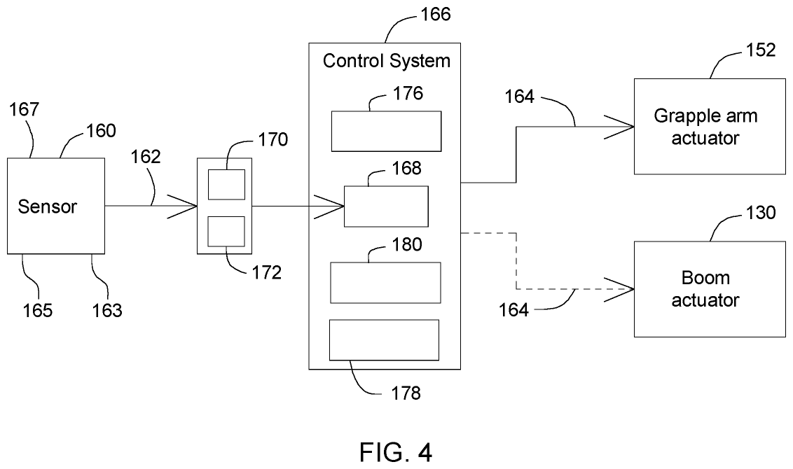

In one embodiment, as shown in FIGS. 2A-4, a sensor 160 is provided such that the sensor 160 senses cutting of the tree 144 by the saw 140. The sensor 160 is configured to output a first signal 162 when the tree 144 is cut by the saw 140. In one embodiment, the sensor 160 is coupled to the grapple arm 146. The sensor 160 may be a pressure sensor 163 that senses increased pressure when the saw 140 has cut the tree 144 and the tree 144 starts to fall. Alternatively, the sensor 160 may be a load sensor 165 which measures the load on the grapple arm 146, or a hydraulic pressure sensor 167, which measures the hydraulic fluid pressure within or provided to the grapple arm actuator 152. Alternatively, the sensor 160 may be coupled to other components of the tree felling head 118.

A control system 166 is in communication with the grapple arm actuator 152 and the sensor 160. The control system 166 receives the first signal 162 output by the sensor 160 and outputs a second signal 164 to cause the grapple arm actuator 152 to move the grapple arm 146 to the gliding position 156 when the first signal 162 output by the sensor 160 is received. In one embodiment, the control system 166 may include an electronic control unit 168 on the work vehicle 100 that communicates with the sensor 160 by means of a communication bus 170 or a wireless communication 172. The control system 166 may output the second signal 164 to the grapple arm actuator 152 to move the grapple arm 146 to the gliding position 156 for less than ten seconds. Alternatively, the grapple arm 146 may be moved to the gliding position 156 for more or less than 10 seconds. The grapple arm actuator 152 may move the grapple arm 146 to the open position 158 automatically after the set time period elapses.

In another embodiment, the control system 166 may be configured to output the second signal 164 to the grapple arm actuator 152 and the boom actuator 130 to move the grapple arm 146 to the gliding position 156 and move the boom assembly 114 in an upward direction 174 (FIG. 1), away from the surface 105 (FIG. 1). Alternatively, the control system 166 may be configured to output the second signal 164 to the grapple arm actuator 152 to move the grapple arm 146 to the gliding position 156 and simultaneously output the second signal 164 to the boom actuator 130 to move the boom assembly 114 in the upward direction 174.

The control system 166 may comprise one or more processors 176 and a non-transitory computer-readable storage medium or memory 178 coupled to the one or more processors 176 and storing programming instructions 180 for execution by the one or more processors 176. The programming instructions 180 may instruct the one or more processors 176 to output the second signal 164 to the grapple arm actuator 152 to move the grapple arm 146 to the gliding position 156 when the first signal 162 output by the sensor 160 is received.

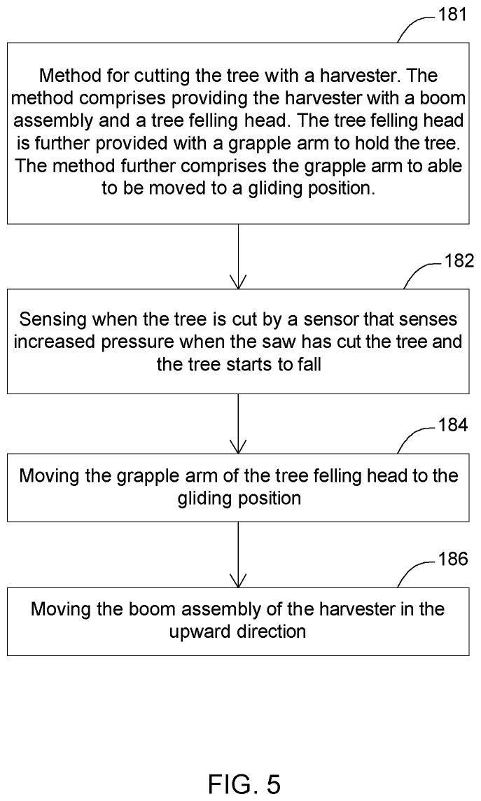

Referring now to FIG. 5, a method for cutting the tree 144 with the harvester 103 is disclosed. In step 181, the harvester 103 is provided with the boom assembly 114 and a tree felling head 118. The method for cutting the tree 144 with the harvester 103 further comprises step 182 that includes sensing when the tree 144 is cut by a saw 140 of the tree felling head 118. The method comprises a step 184 that includes moving the grapple arm 146 of the tree felling head 118 to the gliding position 156. In an embodiment, the grapple arm 146 of the tree felling head 118 may include a pair of grapple arms 146A, 146B.

The step 182 of sensing when the tree 144 is cut may include a sensor 160 that senses increased pressure when the saw 140 has cut the tree 144 and the tree 144 starts to fall.

The method of cutting the tree 144 with the harvester 103 may further include moving the grapple arm 146 of the tree felling head 118 to the gliding position 156 for less than ten seconds.

The method of cutting the tree 144 with the harvester 103 may further include a step 186 of moving the boom assembly 114 of the harvester 103 in the upward direction 174. Further, the two steps (184 and 186) of moving the grapple arm 146 of the tree felling head 118 to the gliding position 156 and moving the boom assembly 114 of the harvester 103 in the upward direction 174 may be performed simultaneously.

What is claimed is:

1. A tree felling head coupled to a boom assembly of a harvester, the tree felling head comprising:
a frame;
a saw coupled to the frame and configured to cut a tree;
a sensor that senses cutting of the tree by the saw and that outputs a first signal when the tree is cut by the saw;
a grapple arm coupled to the frame;
at least one grapple arm actuator coupled to the frame and the grapple arm and configured to move the grapple arm between a closed position in which the tree is held by the tree felling head, a gliding position in which the tree is allowed to slide relative to the tree felling head, and an open position in which the tree is released from the tree felling head; and
a control system in communication with the grapple arm actuator and the sensor, the control system that receives the first signal output by the sensor and outputs a second signal to cause the grapple arm actuator to move the grapple arm to the gliding position when the first signal output by the sensor is received.

2. The tree felling head of claim 1, wherein the saw comprises a bar and chain.

3. The tree felling head of claim 1, wherein the control system outputs the second signal to cause the grapple arm actuator to move the grapple arm to the gliding position for less than ten seconds.

4. The tree felling head of claim 1, wherein the sensor is coupled to the grapple arm and wherein the sensor comprises a pressure sensor that senses increased pressure when the saw has cut the tree and the tree starts to fall.

5. The tree felling head of claim 1, further comprising a boom actuator coupled to the boom assembly, the control system configured to output the second signal to cause the grapple arm actuator and the boom actuator to move the grapple arm to the gliding position and move the boom assembly in an upward direction.

6. The tree felling head of claim 1, wherein the grapple arm comprises a pair of grapple arms and wherein the grapple arm actuator comprises a pair of grapple arm actuators.

7. The tree felling head of claim 1, wherein the control system comprises one or more processors and a non-transitory computer-readable storage medium coupled to the one or more processors and storing programming instructions for execution by the one or more processors, the programming instructions instructing the one or more processors to output a second signal to cause the grapple arm actuator to move the grapple arm to the gliding position when the first signal output by the sensor is received.

8. A harvester comprising:
an upper frame assembly;
a boom assembly coupled to the upper frame assembly;
a tree felling head coupled to the boom assembly, the tree felling head comprising:
a frame;
a saw coupled to the frame and configured to cut a tree;
a sensor that senses cutting of the tree by the saw and that outputs a first signal when the tree is cut by the saw;
a grapple arm coupled to the frame;
at least one grapple arm actuator coupled to the frame and the grapple arm and configured to move the grapple arm between a closed position in which the tree is held by the tree felling head, a gliding position in which the tree is allowed to slide relative to the tree felling head, and an open position in which the tree is released from the tree felling head; and
a control system in communication with the grapple arm actuator and the sensor, the control system that receives the first signal output by the sensor and outputs a second signal to cause the grapple arm actuator to move the grapple arm to the gliding position when the first signal output by the sensor is received.

9. The harvester of claim 8, wherein the saw comprises a bar and chain.

10. The harvester of claim 8, wherein the control system outputs the second signal to cause the grapple arm actuator to move the grapple arm to the gliding position for less than ten seconds.

11. The harvester of claim 8, wherein the sensor is coupled to the grapple arm and wherein the sensor comprises a pressure sensor that senses increased pressure when the saw has cut the tree and the tree starts to fall.

12. The harvester of claim 8, further comprising a boom actuator coupled to the upper frame assembly and the boom assembly, the control system configured to output the second signal to cause the grapple arm actuator and the boom actuator to move the grapple arm to the gliding position and move the boom assembly in an upward direction.

13. The harvester of claim 8, wherein the grapple arm comprises a pair of grapple arms and wherein the grapple arm actuator comprises a pair of grapple arm actuators.

14. The harvester of claim 8, wherein the control system comprises one or more processors and a non-transitory computer-readable storage medium coupled to the one or more processors and storing programming instructions for execution by the one or more processors, the programming instructions instructing the one or more processors to output a second signal to cause the grapple arm actuator to move the grapple arm to the gliding position when the first signal output by the sensor is received.

15. A method for cutting a tree with a harvester comprising a boom assembly and a tree felling head, the method comprising:
sensing when the tree is cut by a saw of the tree felling head; and
moving a grapple arm of the tree felling head to a gliding position.

16. The method of claim 15, further comprising moving the boom assembly of the harvester in an upward direction.

17. The method of claim 15, wherein the grapple arm of the tree felling head is moved to the gliding position for less than ten seconds.

18. The method of claim 15, wherein the sensing is performed by a pressure sensor that senses increased pressure when the saw has cut the tree and the tree starts to fall.

19. The method of claim 16, wherein moving the grapple arm of the tree felling head to a gliding position and moving the boom assembly of the harvester in an upward direction are performed simultaneously.

20. The method of claim 15, wherein the grapple arm includes a pair of grapple arms.
